(19) United States
(12) Patent Application Publication
(10) Pub. No.: US 2005/0131732 A1
(43) Pub. Date: Jun. 16, 2005

(54) Automated survey and report system

(76) Inventor: John J. Potenza, San Diego, CA (US)

Correspondence Address: DON E. ERICKSON;STE. 104 #627, 7668 EL CAMINO REAL, LA COSTA, CA, 92009, US

(21) Appl. No.: 11/049,123

(22) Filed: Feb. 3, 2005

Related U.S. Application Data
(62) Division of application No. 09/832,622, filed on Apr. 11, 2001.

(51) Int. Cl. G06F 17/60

(52) U.S. Cl. 705/1; 705/10

(57) ABSTRACT

The present invention describes an interactive method for assisting in the management of a service provider having at least one manager, at least one employee and at least one service evaluator wherein the at least one service evaluator contacts for assessing the performance of the at least one employee. The evaluation processor obtains evaluation data and a unique service evaluator identifier from the service evaluator, and evaluation processor obtains the unique service evaluator identifier from the service provider. The evaluation processor then provides correlated information from the evaluation data to the manager whereby the manager may evaluate the service provided by the at least one employee to the at least one service evaluator. The correlated information may cause the generation of various information, including business strategies and recommendations to aid in the management of the business.

This application is a divisional application of U.S. patent application Ser. No. 09/832,622 filed Apr. 11, 2001.

### FIELD OF THE INVENTION

The present invention relates to an automated system and method for collecting customer information and combining that information with data from an enterprise to produce continuously changing data that management of the enterprise can use for day-to-day employee management and other forms of analysis and decision making.

### BACKGROUND OF THE INVENTION

The last several decades of the 20^{th} Century engendered a major shift in the economies of the developed nations of the world, from a manufacturing and product-based economy to an information and service-based economy. At the beginning of the 21st Century, this transformation had begun spreading even to the lesser-developed nations. Businesses spend billions collecting customer data because they need to know how they are performing in order to make positive changes. However, businesses have not been able to use customer feedback as an effective proactive management tool because the data is “too little, too late, too biased and not very actionable”

For business enterprises, a change is mandated restructuring of underlying business models, operating processes, and marketing techniques from top to bottom. For service-reliant businesses, in which the customer's satisfaction with the Employee/Customer point of contact may even be the key market differentiator, businesses need accurate and timely feedback on the customer's view of that interaction in order to effect positive change. To maintain the quality of the essential product of a service-based business, the Employee/Customer interaction, rapid and focused employee training is essential to the success of the enterprise, resulting in long-term retention of employees, a crucial contributor to the success of the enterprise. Instant customer feedback is a key differentiator, providing a significant competitive advantage. New communications technologies permit never-before-achieved speed, efficiency and economies in collecting, analyzing and distributing point-of-sale information.

### DESCRIPTION OF THE PRIOR ART

The time-honored techniques for providing feedback from customers, and variations of this technique have been adapted to the new telecommunications and internet technologies, in an attempt to meet the great need. Basically the prior art solution to the problem is to conduct market research, analyze the results, assess and select strategy/solution, develop a program, and implement the program. Although this process is sometimes successful in implementing long-term business strategies, it is rarely used (or useful) for day-to-day management of employees, since timeliness on that scale is difficult to obtain. The present invention addresses these problems, and provides a feedback and reporting system supported by business improvement strategies enabling enterprises, for the first time, real time and proactive employee management opportunities.

### SUMMARY OF THE INVENTION

An object of the invention is to provide service-reliant businesses with an effective system of monitoring, evaluating, and managing employee performance and customer satisfaction. The present invention is directed to mechanisms for obtaining, and utilizing feedback from customers and from employees with a distinctive methodology that maximizes the use of the information collected from the customer and/or employee. More particularly, the invention integrates computer, telephone and Internet technologies to capture point-of-sale customer and employee feedback. For the purposes of the description of the invention, the customer or employee who inputs evaluation data and information shall be referred to as the “service evaluator.”

The point-of-sale information is accumulated on a unit-by-unit basis, and correlated with the identification of the employee directly responsible at the purchaser-provider interface. The correlated point-of-sale/employee information is then reported to management and supported by problem-specific business improvement strategies in a form that enables management to manage and train the employee in a manner most conducive to improving the business. In addition, the raw service evaluator data may be sent directly to the point of sale system or enterprise for subsequent integration into the point-of-sale system to provide the employee direct feedback from the service evaluator, thus transforming the correlated information into a powerful real-time management tool to improve employee performance and maximize service evaluator satisfaction. For example, the service evaluator may be buying tires from the Goodyear Tire Company, or hamburgers from McDonald's, etc. Conversely, the service evaluator may be receiving warranty service from Toyota Motor Company. In either case, whether the purchase is of a product or a service, the invention shall be discussed in the terms of the enterprise being the service provider. At the time of purchase, the service evaluator then becomes an evaluator of both the product/service and the manner in which the service provider dealt with the service evaluator, both of which are of interest to the management of the enterprise. The system of the invention shall be referred to as the “evaluation processor” which may be automated to perform multiple activities, including computerized/automated survey, data conversion, and report delivery, all of which may be supported by specific improvement tools, i.e., tools by which enable the service provider to educate and train its employees, thus serving as a solution provider.

A further object of the invention is to provide employee feedback from the employee of the service provider to its management. It should be appreciated that the same concepts of an independent data/survey collection mechanism as described above would similarly function to enable management to obtain feedback from the employee concerning employee attitudes, perceived working conditions, management styles, methods of improving the service, and other topics of employee/management concern. Similarly, incentives may be provided to the employee to induce his/her cooperation to provide operational input, and anonymity ensured to encourage candid feedback. In such an application, an identifier may be a unique business number, such as a telephone number. The employer may wish to obtain various information from the employee, including employee profiling, to determine the most beneficial means of training the employee, or providing incentives to the employee to maximize the employee's performance.

### DESCRIPTION OF THE DRAWINGS

FIG. 1 is a schematic block diagram of the architecture of the system of the invention.

FIG. 2 is a schematic block diagram of the architecture of the provider-evaluation matching process of the system of the invention.

### DETAILED DESCRIPTION OF THE INVENTION

In a first exemplary embodiment of the invention, the service evaluator obtains the product at a point-of-sale (POS) transaction from the service provider. At the time of purchase, the service provider inputs information to the evaluation processor 10 via service input means 100 to the point-of-transaction record keeping process 200, which compiles and stores the event specific identifier and transaction data in a transaction database 300. The service provider, during the transaction, provides the service evaluator an incentive to participate in evaluating the service provided by the service provider. The incentive may be in the form of a rebate, a discount off the purchase price of the next purchase of the product/service, or any other suitable incentive. It should be noted that, while in the preferred embodiments of the invention the service provider provides the incentive for the service evaluator to contact the evaluation processor, such incentive may be provided by the entity providing the evaluation processor, or any other interested entity.

Subsequent to the transaction, the service evaluator inputs evaluation information to the evaluation processor 10 via recipient-evaluator input means 400 to an automated survey administration and response collection means 500. Input means 400 may be any suitable means of communication, i.e., telephone, the Internet via a computer, or any other suitable communications device. Evaluation processor 10 includes an automated survey administration and response collection means 500, whereby the service evaluator inputs to collection means 500 evaluation data by which the product may be evaluated. The evaluation data inputted by the service evaluator may include a specific evaluator identification (such as a telephone number, address, email address, or equivalent identifier), a transaction identification (such as an invoice number or data of transaction), and evaluative data (pertaining to the quality of the service, or various aspects thereof).

Response collection means 500 correlates the inputted evaluation data and saves it in a recipient feedback survey results database 600 for subsequent processing by provider-recipient matching process 700. In the preferred embodiment, automated survey administration and response collection means 500 is an integrated query/response system that automatically asks several questions of the service evaluator, generally related to the service provider/recipient interaction or to other selected aspects of employee performance and stores such information in the survey results database 600. An example of an automated communications system is an Interactive Voice Response (IVR) system, an application of Computer Telephony, that enables the collection of feedback from the service evaluator using survey scripts specifically designed according to technical parameters of the service provider and its products. However it is contemplated that in its most basic form response collection means 500 could be a telemarketing person who collects responses from the service evaluator and inputs them directly into the survey results database 600. On the other extreme, response collection means 500 may be an Internet site, or other electronic tool, at which the responses from the service evaluator are solicited and received through a menu driven inquiry/response selection system and stored on survey results database 600. In such a system, the inquiry/response selection system may simply require the service evaluator to select a particular number on a touch-tone telephone. Alternatively, the inquiry/response selection system may utilize voice recognition technology to record the service evaluator feedback.

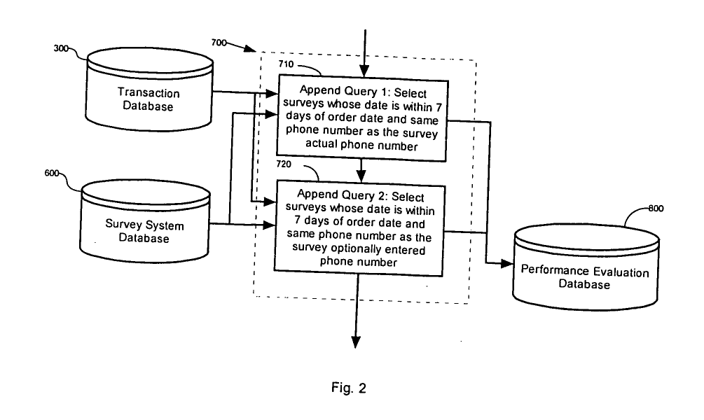

The service evaluator's evaluation data are combined with transaction-specific information by provider-recipient matching process 700, and stored on performance evaluation database 800 for subsequent correlation by performance reporting/presentation process 900. Provider-recipient matching process 700, more fully described in FIG. 2, obtains from transaction database 300 a record that has been entered within a specified time and that contains a transaction, the service provider, the unique service evaluator identifier, and evaluation data via transaction processor 710. Transaction processor 720 survey results database 600 for the last transaction record containing the unique service evaluator identifier entered within the same specified time as the record from the transaction database, and if a match is found, the transaction and evaluation data are extracted and sent to performance reporting/presentation processor 720, which stores the transaction and evaluation data on performance evaluation database 800. If the there is no matching record on survey results database 600, then the evaluation data record is discarded, and the process returns to transaction processor 710 to retrieve another record from transaction database 300 to re-initiate the scan for a matching unique service evaluator identifier. Although FIG. 2 describes the functional sequence of correlating information from transaction database 300 and survey results database 600, such methods are equally applicable to analysis and recommendation process 1600 and provider-entity matching process 2500 described below.

Performance reporting/presentation process 900 then processes the correlated transaction and evaluation data, compiles the correlated data as to the specific service provider, and transmits the reports containing employee specific performance evaluation to the specific service provider on a scheduled basis.

Table 1 depicts a typical report to the service provider relative to performance of its employees.

TABLE 1
Team Member Report
Period 5, 2000
Store 3456
Manager: Seth Smith Supervisor: Bill Blight

| Customer Service | Order | Resp. | CSR | Sides | Surveys |
|---|---|---|---|---|---|
| Representative | Count | Rate | Rating | Off'd | with Sides |
| Mcgovern, Sean | 958 | 0.84% | 96% | 88% | 25% |
| Seaman, Deborah | 1530 | 0.52% | 83% | 100% | 50% |
| Hollins, Denise | 643 | 1.09% | 81% | 43% | 43% |
| Reno, Lisa | 1581 | 0.38% | 89% | 83% | 67% |
| | Order | Resp. | Driver | Within | Order |
| Delivery Driver | Count | Rate | Rating | Time | Correct |
| Mcgovern, Sean | 958 | 0.84% | 96% | 88% | 25% |
| Seaman, Deborah | 1530 | 0.52% | 83% | 100% | 50% |
| Hollins, Denise | 643 | 1.09% | 81% | 43% | 43% |
| Reno, Lisa | 1581 | 0.38% | 89% | 83% | 67% |

In a second exemplary embodiment of the invention, and where service evaluator input means 400 is in direct/indirect communications with the service provider, such as with the Internet, evaluation process 10 performs the same steps and methods as described above through the step of storing the transaction and evaluation data on performance evaluation database 800. However, in addition to the capability of providing scheduled reports, performance reporting/presentation process 900 identifies the specific service provider and directly/indirectly communicates to the service provider manager the employee-specific performance evaluation at or about the time of entry of the service evaluator evaluation data to evaluation processor 10, thereby enabling real-time evaluation, supervision, and/or training of the employee.

It should be appreciated that performance reporting/presentation process 900 can provide variety of reports based on the performance evaluation of the service provider's performance, and the general perceptions of the service provider itself. Performance reporting/presentation process 900 could simply provide a compilation of evaluator responses. At the other extreme, performance reporting/presentation process 900 could provide employee-specific performance evaluation reports, recommended methods of training the employee(s), and other information to provide better service in that particular service industry, with communication via Internet, computer-to-computer interaction, facsimile, etc. Additionally, the information can be used to develop proprietary business improvement solutions unique to that business. All of such reports, strategies, improvement solutions, etc. may be selected by the service provider and may collectively referred to as selected service provider information.

It should be noted that management of the service provider alternatively may obtain the various selected service provider information directly and interactively by accessing reporting/presentation process 900 via telephone, Internet, or other electronic communications systems. Concomitantly, evaluation processor 10 may advise the enterprise of the availability of the various selected service provider information by telephone, email, or other equivalent means, thereby enabling the enterprise to access evaluation processor 10 to obtain the various selected service provider information.

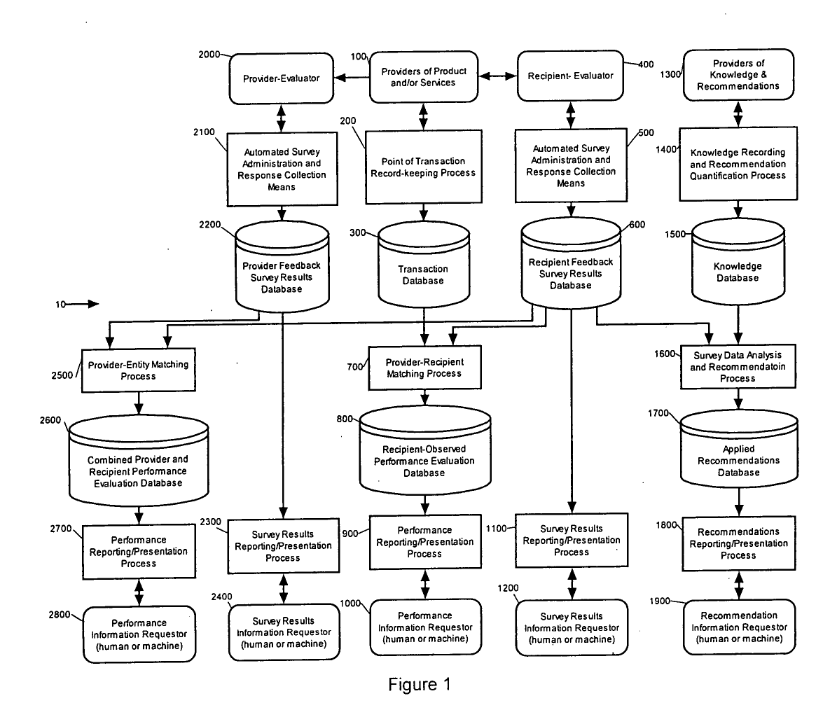

Referring again to FIG. 1, a third exemplary embodiment is described. As in the first preferred embodiment above, the service evaluator inputs evaluation information to the evaluation processor 10 via recipient-evaluator input means 400 to an automated survey administration and response collection means 500. The service evaluator inputs to collection means 500 evaluation data by which the product may be evaluated. As above, the evaluation data inputted by the service evaluator may include a specific evaluator identification (such as a telephone number, address, email address, or equivalent identifier), a transaction identification (such as an invoice number or data of transaction), and evaluative data (pertaining to the quality of the service, or various aspects thereof). This evaluative data may be initialized and reset by the service provider.

Response collection means 500 correlates the inputted evaluation data and saves it in survey results database 600 for subsequent processing by analysis and recommendation process 1600. Also as in the first preferred embodiment, automated survey administration and response collection means 500 is an integrated query/response system that automatically asks several questions of the service evaluator, generally related to the service provider/recipient interaction or to other selected aspects of employee performance and stores such information in the survey results database 600. Referring now to knowledge and recommendations provider 1300 which inputs information relating to a variety of static components, such as business improvement strategies, industry specific, non-generalized strategies, and client specific thresholds, which are received and categorized through processor 1400, and stored on knowledge database 1500. These static components are formulations and strategies preexisting developed and tested methods for aiding and assisting business managers in optimizing their businesses. They may be either generic or industry specific.

Analysis and recommendation process 1600 inputs information from survey results database 600 and converts such information to scores, percentages, etc. which are measures of the evaluation by the service evaluator. Survey data analysis and recommendation process 1600 obtains from recipient feedback survey results database 600 a record that has been entered within a specified time and that contains a transaction, the service provider, the unique service evaluator identifier, and evaluation data.

Analysis and recommendation process 1600 correlates the information stored on survey results database 600 and correlates such information with the report requirements for the specific service provider. Based on client specific thresholds, a selected report or recommendation is generated and stored on applied recommendation database 1700 for subsequent processing by recommendation reporting/presentation process 1800 and for later access or retrieval by the management of the service provider as part of the selected service provider information. Different reports may be generated by recommendation reporting/presentation process 1800 which report or strategy may vary on the goals and/or thresholds of the service provider. The service provider has the ability to set or reset goals to cause the generation of differing improvements strategies for various thresholds selected by the service provider.

Survey data analysis and recommendation process 1600 may additionally obtain from transaction database 300 a record that has been entered within a specified time and that contains a transaction, the service provider, the unique service evaluator identifier for correlation with the information of the service evaluator which then enables employee specific evaluation reports and recommendations on employee training, goal setting, employee incentives, and methods by which the employee may improve service, which then become selected service provider information.

Referring again to FIG. 1, a fourth embodiment is described wherein the employee is the service evaluator, providing input to the management of the business from the prospective of the employee. There are various means by which the employee may be given the incentive to provide such evaluation, such a bonuses, compensation, and/or compensatory time off, etc. In its simplest form, the employee/service evaluator 2000 inputs data to the administration and response collection means 2100. The data provided may be transaction specific as it relates to the provision of services to a particular client on a specific date, or the data may be or a more general nature. Additionally or alternatively, the data inputted may be descriptive of the employee's attitudes, preferences, or provide a sociological profile of the employee. Administration and response collection means 2100 stores such information on provider feedback survey results database 2200. Survey results reporting/presentation process 2300 correlates such information with the identity of the service provider and makes such information available to the service provider via survey results information requestor 2400 as in any of the methods described above. Such employee information may also be correlated with information from other employees to provide a more statistical evaluation of the manner in which the service is provided, or how the management of the service provider is perceived.

Alternately, provider-entity matching process 2500 may identify the service evaluator-inputted evaluation data and stored in survey results database 600 for correlation with the employee evaluation data, and stores such correlation on combined provider and recipient performance evaluation database 2600. As in the first preferred embodiment above, the service evaluator inputs evaluation information to the evaluation processor 10 via service evaluator input means 400 to an automated survey administration and response collection means 500. The service evaluator inputs to collection means 500 evaluation data by which the product may be evaluated. As above, the evaluation data inputted by the service evaluator may include a specific evaluator identification (such as a telephone number, address, email address, or equivalent identifier), a transaction identification (such as an invoice number or data of transaction), and evaluative data (pertaining to the quality of the service, or various aspects thereof).

Response collection means 500 correlates the inputted evaluation data and saves it in survey results database 600 for subsequent processing by analysis and recommendation process 1600. As in the first preferred embodiment, automated survey administration and response collection means 500 is an integrated query/response system that automatically asks several questions of the service evaluator, generally related to the service provider/recipient interaction or to other selected aspects of employee performance and stores such information in the survey results database 600. Performance reporting/presentation process 2700 assesses such correlated information and formats selected service provider information based on the evaluation of the service by the recipient, and the perception of the service provided by the employee/evaluator, which selected service provider information are accessed or obtained through performance information requestor 2800.

While the present description contains much specificity, this should not be construed as limitations on the scope of the invention, but rather as examples of some preferred embodiments thereof. Accordingly, the scope of the invention should not be determined by the specific embodiments illustrated herein. The full scope of the invention is further illustrated by the claims appended hereto.

1. A method for providing transactional service information to a service provider having at least one manager and at least one service evaluator, the at least one service evaluator being an employee of the service provider, the method comprising the steps of:
a. the at least one service evaluator providing evaluation data to an automated evaluation processor, the evaluation processor for obtaining evaluation data from the at least one service evaluator and service provider information from the service provider;
b. the service provider providing service provider information to the evaluation processor;
c. the evaluation processor correlating the evaluation data and the service provider information to create a correlated data file; and
d. the evaluation processor storing the correlated data file for retrieval by the at least one manager.

2. The method of claim 1 wherein the evaluation data includes a unique identifier of the at least one service evaluator.

3. The method of claim 2 wherein the service provider information includes a unique identifier of the service provider.

4. The method of claim 3 wherein the service provider information includes the unique identifier of the at least one service evaluator.

5. The method of claim 4 wherein the step of the evaluation processor correlating the evaluation data and the service provider information to create a correlated data file includes the correlation of the unique identifier provided by the at least one service evaluator with the unique identifier of the at least one service evaluator provided by the service provider, and using the evaluation data to assess the performance of the at least one service evaluator with at least one customer of the service provider.

6. The method of claim 4 wherein the service provider information includes personality data of the at least one service evaluator.

7. The method of claim 6 wherein the correlated data file includes a personality profile of the at least one service evaluator.

8. The method of claim 1 wherein the step of the evaluation processor storing the correlated data file includes the step of the at least one manager retrieving the correlated data file.

9. The method of claim 8 wherein the at least one manager retrieves the correlated data file through the Internet.

10. The method of claim 8 wherein the step of the evaluation processor obtaining evaluation data from the at least one service evaluator and the step of the at least one manager retrieving the correlated data file is performed interactively.

11. The method of claim 10 wherein the interactivity is through the Internet.

12. The method of claim 1 wherein the step of the evaluation processor storing the correlated data file includes the step of the evaluation processor automatically sending selected information from the correlated data file to the at least one manager.

13. The method of claim 1 wherein the step of the at least one service evaluator providing evaluation data to the evaluation processor includes the step of the service provider providing the at least one service evaluator an incentive for the at least one service evaluator to contact the evaluation processor.

14. The method of claim 1 wherein the step of the evaluation processor obtaining evaluation data from the at least one service evaluator includes the step of receiving the evaluation data by means of an inquiry/response system.

15. The method of claim 12 wherein the inquiry/response system is automated.

16. The method of claim 13 wherein the automated inquiry response system is accessed by a telephone.

17. The method of claim 13 wherein the automated inquiry system is accessed through the Internet.

18. A method for providing transactional service information to a service provider having at least one manager and at least one service evaluator, the at least one service evaluator being an employee of the service provider, the method comprising the steps of:
a. the at least one service evaluator providing evaluation data to an automated evaluation processor, the evaluation processor for obtaining evaluation data from the at least one service evaluator and service provider information from the service provider, the evaluation data including a unique identifier of the at least one service evaluator;
b. the service provider providing service provider information to the evaluation processor, the service provider information including a unique identifier of the service provider and a unique identifier of the service provider;
c. the evaluation processor correlating the evaluation data and the service provider information to create a correlated data file; and
d. the evaluation processor storing the correlated data file for retrieval by the at least one manager.

19. The method of claim 18 wherein the step of the evaluation processor storing the correlated data file includes the step of the at least one manager retrieving the correlated data file.

20. The method of claim 19 wherein the actions of the at least one service evaluator, the service provider and the at least one manager are conducted through the Internet.
